(19) United States
(12) Patent Application Publication
(10) Pub. No.: US 2013/0258716 A1
(43) Pub. Date: Oct. 3, 2013

(54) BLACKLIGHT MODULE AND LIQUID CRYSTAL DISPLAY

(71) Applicant: Kuojun Fang, Guangdong (CN)

(72) Inventor: Kuojun Fang, Guangdong (CN)

(73) Assignee: SHENZHEN CHINA STAR OPTOELECTRONICS TECHNOLOGY CO., LTD., Guangdong (CN)

(21) Appl. No.: 13/697,759

(22) PCT Filed: Apr. 9, 2012
(86) PCT No.: PCT/CN2012/073654

§ 371 Date: Nov. 13, 2012

(30) Foreign Application Priority Data
Mar. 29, 2012 (CN) 201210088311.9

(51) Int. Cl. G09F 13/04

(52) U.S. Cl. CPC G09F 13/04
USPC 362/613

(57) ABSTRACT

The present invention discloses a backlight module and a liquid crystal display (LCD). A backlight module comprising a plurality of refractive structures, and each of the refractive structure comprises a first refractive surface and a second refractive surface. The first refractive surface and the second refractive surface have a first inclined angle and a second inclined angle, respectively. The lights from the light source corresponding to the refractive structure emitted to the first refractive surface are through the refractive structure by the refraction of the first refractive surface; the lights from the light source corresponding to the refractive structure emitted to the second refractive surface are through the refractive structure by the refraction of the second refractive surface.

### FIELD OF THE INVENTION

The present invention relates to a field of liquid crystal display technology, and more particularly to a backlight module and a liquid crystal display (LCD).

### BACKGROUND OF THE INVENTION

With a liquid crystal display (LCD) development trend toward light-thin, the quantity of the needed Light Emitting Diode (LED) is less and less.

Referring now to FIG. 1, in side light type LED backlight module, the quantity of the LEDs is decreased, so it causes the pitch P′ between the LEDs is increased. The lights emitted from LED 11 enter into a light guide plate 12. Because the density of the light guide plate 12 is different with the density of air, it is generally smaller than the density of air, there is a refractive effect to the lights.

One part of the lights emitted from the LED 11 are perpendicularly enter into the light guide plate 12, and the angular aperture of the part of perpendicular light-in lights: θₐᵢᵣ=90°. When the part of lights enter into the light guide plate 12, the angular aperture is decreased: θ_{LGP}=arcsin(1/n_{LGP}), θ_{LGP}<90°.

For the lights concentrated around the perpendicular light-in lights, if the θ_{LGP} is smaller, in a condition of mixed light distance d is fixed, it will cause the part of lights concentrated at a certain area of the light guide plate 12, so that the light guide plate 12 appears a Mura (hotspot) phenomenon.

How to solve the technological problem of Mura phenomenon in the light guide plate, which the perpendicular light-in lights and the lights concentrated around the perpendicular light-in lights enter into the light guide plate and are concentrated at a certain area of the light guide plate, is become one of the research directions of the field of liquid crystal display technologies.

### SUMMARY OF THE INVENTION

One of the objects of the present invention is to provide a backlight module, which can solve a technologic problem: in traditional technology, a light guide plate has a refractive effect to the lights emitted thereinto, so it causes a Mura phenomenon in the light guide plate.

To solve above-mentioned problem, the present invention constructs a backlight module, which comprising: a light guide plate and a plurality of light sources, wherein the light guide plate comprises a light-in surface, and the light sources are near the light-in surface; the light guide plate is provided with a plurality of refractive structures, and the refractive structures are corresponding to the light sources;

wherein each of the refractive structure comprises a hollow structure, and a transparent material is filled into the hollow structure; the refractive index of the transparent material is smaller than the refractive index of the light guide plate;

wherein each of the refractive structure comprises a first refractive surface, a second refractive surface and a third refractive surface, and the third refractive surface connects with the first refractive surface and the second refractive surface; the first refractive surface has a first inclined angle along a perpendicular light-in direction which is from the light source to the light guide plate and is horizontal-perpendicular to a light-in surface; the second refractive surface has a second inclined angle along the perpendicular light-in direction, and the inclined direction of the first inclined angle and the second inclined angle is opposite; a maximum distance between the third refractive surface and the light-in surface of the corresponding light guide plate is smaller than a mixed light distance; and

wherein in the first inclined angle, the lights from the light source which are corresponding to the refractive structure emitted to the first refractive surface are through the refractive structure by the refraction of the first refractive surface; in the second inclined angle, the lights from the light source which is corresponding to the refractive structure emitted to the second refractive surface are through the refractive structure by the refraction of the second refractive surface.

In the backlight module of the present invention, the hollow structure has a refractive length along a perpendicular direction between the light source and the light guide plate, and the refractive length is smaller than the mixed light distance of the backlight module.

In the backlight module of the present invention, the first inclined angle β1 can satisfy a condition as follow:

β1≦45°−arcsin(1/n_{LGP});

wherein nLGP is the refractive index of the light guide plate.

In the backlight module of the present invention, the first inclined angle β2 can satisfy a condition as follow:

β2≦45°−arcsin(1/n_{LGP});

wherein nLGP is the refractive index of the light guide plate.

Another one of the objects of the present invention is to provide a backlight module, which can solve problems: in traditional technology, a light guide plate has a refractive effect to the lights emitted thereinto, so it causes a Mura phenomenon in the light guide plate.

To solve above-mentioned problem, the present invention constructs a backlight module, which comprising: a light guide plate and a plurality of light sources, wherein the light guide plate comprises a light-in surface, and the light sources are near the light-in surface; the light guide plate is provided with a plurality of refractive structures, and the refractive structures are corresponding to the light sources;

wherein each of the refractive structure comprises a first refractive surface, a second refractive surface and a third refractive surface, and the third refractive surface connects with the first refractive surface and the second refractive surface; the first refractive surface has a first inclined angle along a perpendicular light-in direction which is from the light source to the light guide plate and is horizontal-perpendicular to a light-in surface; the second refractive surface has a second inclined angle along the perpendicular light-in direction, and the inclined direction of the first inclined angle and the second inclined angle is opposite; and

wherein in the first inclined angle, the lights from the light source which are corresponding to the refractive structure emitted to the first refractive surface are through the refractive structure by the refraction of the first refractive surface; in the second inclined angle, the lights from the light source which is corresponding to the refractive structure emitted to the second refractive surface are through the refractive structure by the refraction of the second refractive surface.

In the backlight module of the present invention, each of the refractive structure comprises a hollow structure, and a transparent material is filled into the hollow structure; the refractive index of the transparent material is smaller than the refractive index of the light guide plate.

In the backlight module of the present invention, a maximum distance between the third refractive surface and the light-in surface of the corresponding light guide plate is smaller than a mixed light distance; the hollow structure has a refractive length along a perpendicular direction between the light source and the light guide plate, and the refractive length is smaller than the mixed light distance of the backlight module.

In the backlight module of the present invention, the first inclined angle β1 can satisfy a condition as follow:

β1≦45°−arcsin(1/n_{LGP};

wherein nLGP is the refractive index of the light guide plate.

In the backlight module of the present invention, the first inclined angle β2 can satisfy a condition as follow:

β2≦45°−arcsin(1/n_{LGP});

wherein nLGP is the refractive index of the light guide plate.

Further, another one of the objects of the present invention is to provide a liquid crystal display (LCD), which can solve problems: in traditional technology, a light guide plate has a refractive effect to the lights emitted thereinto, so it causes a Mura phenomenon in the light guide plate.

To solve above-mentioned problem, the present invention constructs a LCD, which comprising: a backlight module, wherein the backlight module comprises a light guide plate and a plurality of light sources, wherein the light guide plate comprises a light-in surface, and the light sources are near the light-in surface; the light guide plate is provided with a plurality of refractive structures, and the refractive structures are corresponding to the light sources;

wherein each of the refractive structure comprises a first refractive surface, a second refractive surface and a third refractive surface, and the third refractive surface connects with the first refractive surface and the second refractive surface; the first refractive surface has a first inclined angle along a perpendicular light-in direction which is from the light source to the light guide plate and is horizontal-perpendicular to a light-in surface; the second refractive surface has a second inclined angle along the perpendicular light-in direction, and the inclined direction of the first inclined angle and the second inclined angle is opposite; and

wherein in the first inclined angle, the lights from the light source which are corresponding to the refractive structure emitted to the first refractive surface are through the refractive structure by the refraction of the first refractive surface; in the second inclined angle, the lights from the light source which is corresponding to the refractive structure emitted to the second refractive surface are through the refractive structure by the refraction of the second refractive surface.

In the LCD of the present invention, each of the refractive structure comprises a hollow structure, and a transparent material is filled into the hollow structure; the refractive index of the transparent material is smaller than the refractive index of the light guide plate.

In the LCD of the present invention, a maximum distance between the third refractive surface and the light-in surface of the corresponding light guide plate is smaller than a mixed light distance; the hollow structure has a refractive length along a perpendicular direction between the light source and the light guide plate, and the refractive length is smaller than the mixed light distance of the backlight module.

In the LCD of the present invention, the first inclined angle β1 can satisfy a condition as follow:

β1≦45°−arcsin(1/n_{LGP});

wherein nLGP is the refractive index of the light guide plate.

In the LCD of the present invention, the first inclined angle β2 can satisfy a condition as follow:

β2≦45°−arcsin(1/n_{LGP});

wherein nLGP is the refractive index of the light guide plate.

In comparison with the traditional technologies, in the present invention, by that the refractive structures 22 is disposed in the light guide plate, the refractive structures are corresponding to the light sources, and the refractive structures will refract the perpendicular light-in lights and the lights concentrated around the perpendicular light-in lights, so that this part of lights appear a scattering effect. It can prevent the lights from concentrated at a certain area of the light guide plate, and it can avoid the Mura phenomenon, so as to insure a well image quality of the LCD.

For above-mention contents of the present invention can be best understood by referring to the following detailed description of the preferred embodiments and the accompanying drawings.

### DESCRIPTION OF THE DRAWINGS

FIG. 1 is a structural schematic view of a backlight module in traditional technology;

FIG. 2 is a structural schematic view of a backlight module of a preferred embodiment according to the present invention;

FIG. 3 is a top view of a structural schematic view in FIG. 2;

FIG. 4 is a side view of a structural schematic view in FIG. 2; and

FIG. 5 is schematic view of lights refractive effect of the preferred embodiment according to the present invention.

### DETAILED DESCRIPTION OF THE PREFERRED EMBODIMENTS

The description of the preferred embodiments refers to the drawings, so as to illustrate the specific embodiments of the present invention which can be carried out.

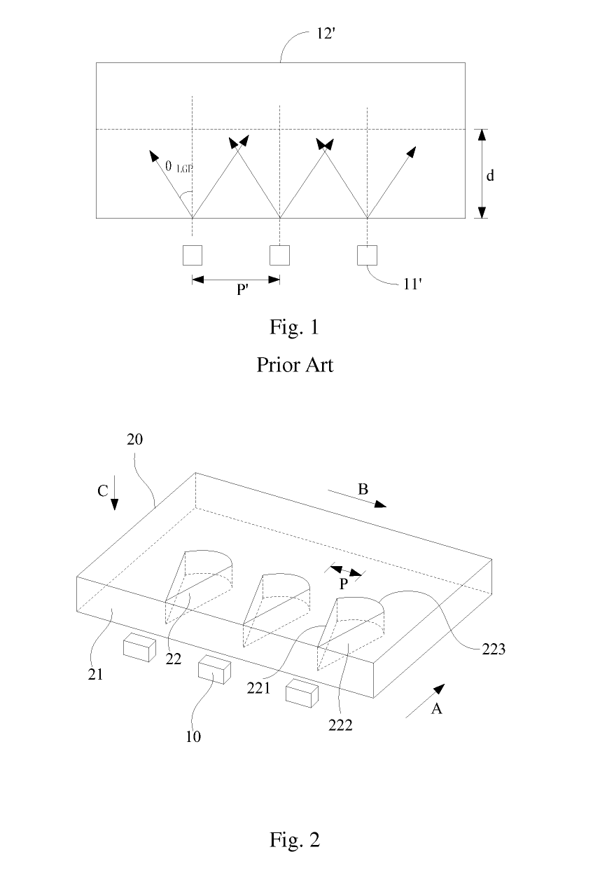

Referring now to FIG. 2, a structural schematic view of a backlight module of a preferred embodiment according to the present invention is illustrated in FIG. 2.

A backlight module comprises light sources 10 and a light guide plate 20, wherein the light guide plate 20 comprises a light-in surface 21, and the light guide plate 20 is provided with a plurality of refractive structures 22. Each of the refractive structure 22 comprises a first refractive surface 221, a second refractive surface 222 and a third refractive surface 223, and all of they are disposed along a thickness direction C of the light guide plate 20. The third refractive surface 223 connects with the first refractive surface 221 and the second refractive surface 222.

The refractive structure 22 is preferably been a hollow structure, and a transparent material is filled into the hollow structure. The refractive index of the transparent material is smaller than the refractive index of the light guide plate 20, so as to achieve refraction for the lights emitted to the refractive structure 22.

The above-mentioned transparent material is preferably been a methyl pentene copolymer (PMP), such as poly(4-methyl-1-pentene) (TPX), refractive index: 1.46; or poly (butyl acrylate) (PBA), refractive index: 1.47. In a specific embodiment process, it is also doped with nanoparticles having low refractive index, so as to lower the refractive index of the transparent material.

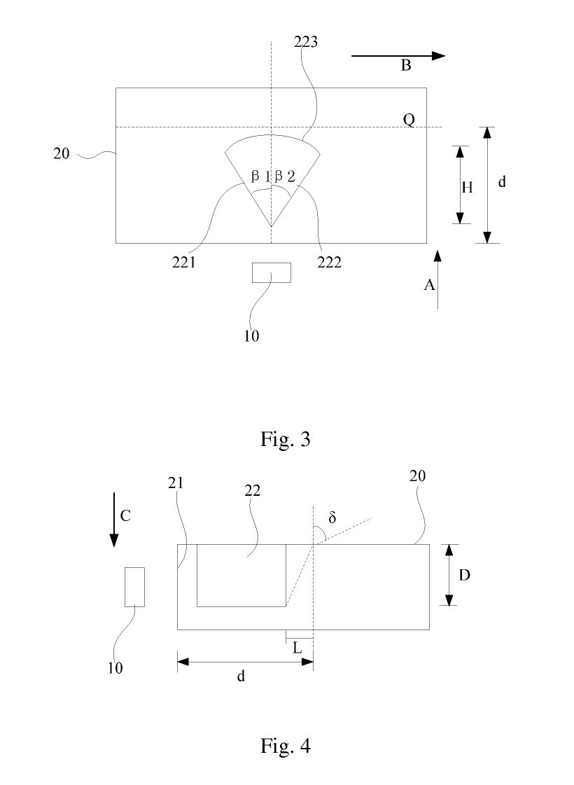

Please referring FIG. 3, simultaneously, along a perpendicular light-in direction A which is from the light source 10 to the light guide plate 20 and is horizontal-perpendicular to the light-in surface. The first refractive surface 221 has a first inclined angle β1, and in the first inclined angle β1, the lights from the light source 20 which are corresponding to the refractive structure 22 emitted to the first refractive surface are through the refractive structure 22 by the refraction of the first refractive surface 221. The second refractive surface 222 has a second inclined angle β2, and in the second inclined angle β2, the lights from the light source 20 which is corresponding to the refractive structure 22 emitted to the second refractive surface 222 are through the refractive structure 22 by the refraction of the second refractive surface 222.

The inclined direction of the first inclined angle β1 and the second inclined angle β2 is opposite. Specifically, the first inclined angle β1 is rotated along counter-clockwise, and the second inclined angle β2 is rotated along clockwise

Furthermore, the first inclined angle β1 can satisfy a condition as follow:

β1≦45°−arcsin(1/n_{LGP});

wherein n_{LGP} is the refractive index of the light guide plate.

In this condition, the first refractive surface 221 can refract the received lights, wherein the lights are emitted from the light source 10 which are corresponding to the refractive structure 22. Besides, the lights are the perpendicular light-in lights and the lights concentrated around the perpendicular light-in lights. By the refraction of the first refractive surface 221, the lights appear a scattering effect, and are through the refractive structure 22, and then continually go forward. It can prevent the lights from concentrated at the light guide plate 20, so that it can avoid the Mura phenomenon of the liquid crystal display (LCD).

Furthermore, the second inclined angle β2 can satisfy a condition as follow:

β2≦45°−arcsin(1/n_{LGP});

In this condition, the second refractive surface 222 can refract the received lights, wherein the lights are emitted from the light source 10 which are corresponding to the refractive structure 22. Besides, the lights are the perpendicular light-in lights and the lights concentrated around the perpendicular light-in lights. By the refraction of the second refractive surface 222, the lights appear a scattering effect, and are through the refractive structure 22, and then continually go forward. It can prevent the lights from concentrated at the light guide plate 20, so that it can avoid the Mura phenomenon of the LCD.

In a specific embodiment process, the third refractive surface 223 is preferably been a plane. In this condition, the refractive structure 22 is a structure of triangle in a plane direction B of the light guide plate 20 (as shown in FIG. 3). Certainly, the third refractive surface 223 also can be a curve, such as an arc surface.

If the third refractive surface 223 is an arc surface, in the horizontal plane B of the light guide plate 20, the included angle between the tangent of any point on the arc and the direction A is smaller than the first inclined angle β1 or the second inclined angle β2. For example, the tangent of a point near the first refractive surface 221 on the third refractive surface 223 and the direction A is smaller than the first inclined angle β1.

Please continually referring FIG. 3, in FIG. 3, the third refractive surface 223 is a plane.

A maximum distance (unlabeled) between the third refractive surface 223 and the light-in surface 21 of the corresponding light guide plate 20 is smaller than a mixed light distance d. The refractive structure 22 has a refractive length H along the direction A, and the refractive length H is smaller than the mixed light distance d of the backlight module, so as to insure the lights can be refracted before mixing.

The first refractive surface 221 and the second refractive surface 222 are preferably planes. Certainly, they are also can be curves. If they are curves, in horizontal plane B, the included angle between the tangent of any point on the curve and the direction A is smaller than the first inclined angle β1 or the second inclined angle β2, so as to avoid the lights refracted back to the light-in surface 21. For example, if the first refractive surface 221 is curve, in horizontal plane B, the included angle between the tangent of any point on the curve and the direction A is smaller than the first inclined angle β1.

Referring to FIG. 4, a side view of a structural schematic view of a backlight module in FIG. 2 according to a preferred embodiment is illustrated in FIG. 4.

The refractive structure 22 has a refractive depth D along the thickness direction C of the light guide plate. A minimum distance L is between the third refractive surface 223 and a mixed light line Q (a line at light cross points of adjacent light sources). The refractive structure 22 has a minimum light-out angular aperture δ on the mixed light line Q. The refractive depth D, the minimum distance L and the minimum light-out angular aperture δ can satisfy the equation:

sin δ≦n_{LGP}×sin(atan(L/D))

The refractive depth D, the minimum distance L and the minimum light-out angular aperture δ can satisfy the above-mentioned equation, so that it can avoid the refractive structure 22 to be seen along the direction of the minimum light-out angular aperture δ.

In the embodiment in FIG. 4, the refractive depth D is smaller than the thickness of the light guide plate 20 (unlabeled). In a specific embodiment process, the refractive depth D also can equal to the thickness of the light guide plate 20, so it is not listed one by one here. The refractive depth D is defined by the depth of the hollow structure of the refractive structure 22. After the hollow structure is formed, it is necessary to fill the transparent material into the hollow structure, so as to form the refractive structure 22.

Please referring FIG. 2, simultaneously, the refractive structures 22 is arranged as a row by the same space on the horizontal plane B, the distance P between the two adjacent refractive structures 22 can satisfy the equation:

P≧d/tan(arcsin(1/n_{LGP}));

In the embodiment, by adjusting the first inclined angle β1 and the second inclined angle β2 of the refractive structures 22, the refractive length H and the location of the corresponding light source 10, it can effectively avoid the Mura phenomenon, so as to insure a well image quality of the LCD.

The third refractive surface 223 is preferably been a curve (the arc surface shown in FIGS. 2 and 3). Certainly, it also can be others shape, such as plane, the detail thereof is not described here.

The operation principle of the preferred embodiment of the backlight module in FIG. 2 to 4 is described as follows:

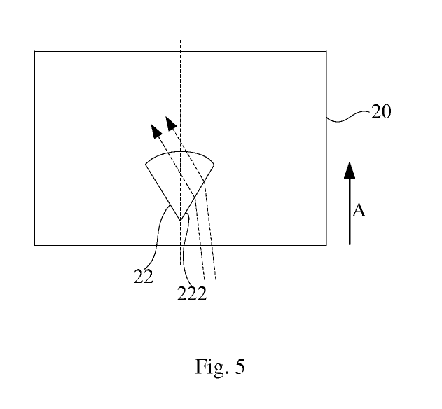

Referring to the FIG. 5, simultaneously, one part of the lights emitted from the light source 10 entering into the light guide plate 20 are the perpendicular light-in lights and the lights concentrated around the perpendicular light-in lights, and this part of lights have smaller refractive angle. For example as the second refractive surface 222 of the refractive structures 22, this part of lights are emitted to the second refractive surface 222, because the second inclined angle β2≦45°−arcsin(1/n_{LGP}), and the material filled into the refractive structures 22 has a smaller refractive index than the refractive index of the light guide plate 20, the part of lights are through the refractive structure 22 by the refraction of the second refractive surface 222, and then continually go forward. The refracted lights appear a scattering effect, so it can prevent the lights from concentrated at a certain area of the light guide plate 20, and then it can avoid the Mura phenomenon, so as to insure a well image quality of the LCD.

The present invention is further provided with a LCD, the LCD comprises a backlight module provided by the present invention. Because the backlight module is described in above text, so it is not repeat here again.

By that the refractive structures 22 is disposed in the light guide plate, the refractive structures are corresponding to the light sources, and the refractive structures will refract the perpendicular light-in lights and the lights concentrated around the perpendicular light-in lights, so that this part of lights appear a scattering effect. It can prevent the lights from concentrated at a certain area of the light guide plate, and it can avoid the Mura phenomenon, so as to insure a well image quality of the LCD.

As described above, the present invention has been described with a preferred embodiment thereof and it is understood that many changes and modifications to the described embodiment can be carried out without departing from the scope and the spirit of the invention that is intended to be limited only by the appended claims.

1. A backlight module, comprising: a light guide plate and a plurality of light sources, wherein the light guide plate comprises a light-in surface, and the light sources are near the light-in surface; the light guide plate is provided with a plurality of refractive structures, and the refractive structures are corresponding to the light sources;
wherein each of the refractive structure comprises a hollow structure, and a transparent material is filled into the hollow structure; the refractive index of the transparent material is smaller than the refractive index of the light guide plate;
wherein each of the refractive structure comprises a first refractive surface, a second refractive surface and a third refractive surface, and the third refractive surface connects with the first refractive surface and the second refractive surface; the first refractive surface has a first inclined angle along a perpendicular light-in direction which is from the light source to the light guide plate and is horizontal-perpendicular to a light-in surface; the second refractive surface has a second inclined angle along the perpendicular light-in direction, and the inclined direction of the first inclined angle and the second inclined angle is opposite; a maximum distance between the third refractive surface and the light-in surface of the corresponding light guide plate is smaller than a mixed light distance; and
wherein in the first inclined angle, the lights from the light source which are corresponding to the refractive structure emitted to the first refractive surface are through the refractive structure by the refraction of the first refractive surface; in the second inclined angle, the lights from the light source which is corresponding to the refractive structure emitted to the second refractive surface are through the refractive structure by the refraction of the second refractive surface.

2. The backlight module according to claim 1, wherein the hollow structure has a refractive length along a perpendicular direction between the light source and the light guide plate, and the refractive length is smaller than the mixed light distance of the backlight module.

3. The backlight module according to claim 1, wherein the first inclined angle β1 can satisfy a condition as follow:
β1≦45°−arcsin(1/n_{LGP});
wherein n_{LGP} is the refractive index of the light guide plate.

4. The backlight module according to claim 1, wherein the first inclined angle β2 can satisfy a condition as follow:
β2≦45°−arcsin(1/n_{LGP});
wherein n_{LGP} is the refractive index of the light guide plate.

5. A backlight module, comprising: a light guide plate and a plurality of light sources, wherein the light guide plate comprises a light-in surface, and the light sources are near the light-in surface; the light guide plate is provided with a plurality of refractive structures, and the refractive structures are corresponding to the light sources;
wherein each of the refractive structure comprises a first refractive surface, a second refractive surface and a third refractive surface, and the third refractive surface connects with the first refractive surface and the second refractive surface; the first refractive surface has a first inclined angle along the perpendicular light-in direction which is from the light source to the light guide plate and is horizontal-perpendicular to a light-in surface; the second refractive surface has a second inclined angle along a perpendicular light-in direction, and the inclined direction of the first inclined angle and the second inclined angle is opposite; and
wherein in the first inclined angle, the lights from the light source which are corresponding to the refractive structure emitted to the first refractive surface are through the refractive structure by the refraction of the first refractive surface; in the second inclined angle, the lights from the light source which is corresponding to the refractive structure emitted to the second refractive surface are through the refractive structure by the refraction of the second refractive surface.

6. The backlight module according to claim 5, wherein each of the refractive structure comprises a hollow structure, and a transparent material is filled into the hollow structure; the refractive index of the transparent material is smaller than the refractive index of the light guide plate.

7. The backlight module according to claim 5, wherein a maximum distance between the third refractive surface and the light-in surface of the corresponding light guide plate is smaller than a mixed light distance; the hollow structure has a refractive length along a perpendicular direction between the light source and the light guide plate, and the refractive length is smaller than the mixed light distance of the backlight module.

8. The backlight module according to claim 5, wherein the first inclined angle β1 can satisfy a condition as follow:
β1≦45°−arcsin(1/n_{LGP});
wherein n_{LGP} is the refractive index of the light guide plate.

9. The backlight module according to claim 5, wherein the first inclined angle β2 can satisfy a condition as follow:
β2≦45°−arcsin(1/n_{LGP});
wherein n_{LGP} is the refractive index of the light guide plate.

10. A liquid crystal display (LCD), comprising a backlight module, wherein the backlight module comprises a light guide plate and a plurality of light sources, wherein the light guide plate comprises a light-in surface, and the light sources are near the light-in surface; the light guide plate is provided with a plurality of refractive structures, and the refractive structures are corresponding to the light sources;
wherein each of the refractive structure comprises a first refractive surface, a second refractive surface and a third refractive surface, and the third refractive surface connects with the first refractive surface and the second refractive surface; the first refractive surface has a first inclined angle along a perpendicular light-in direction which is from the light source to the light guide plate and is horizontal-perpendicular to a light-in surface; the second refractive surface has a second inclined angle along the perpendicular light-in direction, and the inclined direction of the first inclined angle and the second inclined angle is opposite; and
wherein in the first inclined angle, the lights from the light source which are corresponding to the refractive structure emitted to the first refractive surface are through the refractive structure by the refraction of the first refractive surface; in the second inclined angle, the lights from the light source which is corresponding to the refractive structure emitted to the second refractive surface are through the refractive structure by the refraction of the second refractive surface.

11. The LCD according to claim 10, wherein each of the refractive structure comprises a hollow structure, and a transparent material is filled into the hollow structure; the refractive index of the transparent material is smaller than the refractive index of the light guide plate.

12. The LCD according to claim 10, wherein a maximum distance between the third refractive surface and the light-in surface of the corresponding light guide plate is smaller than a mixed light distance; the hollow structure has a refractive length along a perpendicular direction between the light source and the light guide plate, and the refractive length is smaller than the mixed light distance of the backlight module.

13. The LCD according to claim 10, wherein the first inclined angle β1 can satisfy a condition as follow:
β1≦45°−arcsin(1/n_{LGP});
wherein n_{LGP} is the refractive index of the light guide plate.

14. The LCD according to claim 10, wherein the first inclined angle β2 can satisfy a condition as follow:
β2≦45°−arcsin(1/n_{LGP});
wherein n_{LGP} is the refractive index of the light guide plate.
